(19) United States
(12) Patent Application Publication
(10) Pub. No.: US 2002/0074400 A1
(43) Pub. Date: Jun. 20, 2002

(54) Magnetic card with amorphous metal fibers and discriminating device

(76) Inventor: Akira Suzuki, Kawaguchi-Shi (JP)

Correspondence Address: David E Dougherty, Dennison Schultz & Dougherty, 612 Crystal Square 4, 1745 Jefferson Davis Highway, Arlington, VA, 22202, US

(21) Appl. No.: 09/737,865

(22) Filed: Dec. 18, 2000

(51) Int. Cl. G06K 7/08

(52) U.S. Cl. 235/449

(57) ABSTRACT

A magnetic card embedded with amorphous metal fibers and a discriminating device, wherein, the magnetic card is characterized by being braided therein with amorphous metal fibers parallelly arrayed, thereby, when the magnetic card is inserted to be between a driving coil and a detecting coil of the discriminating device, the driving coil forms an alternating magnetic field, and the detecting coil can detect the magnetic signals passing through the amorphous metal fibers, these detected signals are used to discriminate reality and forgery of the magnetic card.

### BACKGROUND OF THE INVENTION

1. Field of the Invention

The present invention is related to a magnetic card embedded with amorphous metal fibers and a discriminating device rendering the magnetic card to take the place of a prepaying card for prepaying money under a predetermined amount, and especially to a highly safe magnetic card capable of preventing forgery, wherein the discriminating device can discriminate reality and forgery of the magnetic card.

2. Description of the Prior Art

Following advancing of science and technology and in consideration of safety, cash transaction has been being gradually diminished, while plastic currency is prevailing. It is well known that, magnetic cards on which personal data are recorded can include credit cards used for payment after purchasing and prepaying magnetic cards for prepaying money under predetermined amounts etc.

Every prepaying magnetic card for prepaying money under a predetermined amount can update the magnetic data of balance each time in use; there is a code for preventing forgery on the updated data. Once the code is decoded, there is no additional way to prevent forgery. Therefore, it is a big problem in an urgent need of solution to give a way to effectively prevent forgery on magnetic cards.

### SUMMARY OF THE INVENTION

The primary object of the present invention is to provide a magnetic card embedded with amorphous metal fibers which can emit signals and prevent forgery.

The secondary object of the present invention is to provide a magnetic card discriminating device to definitely discriminate reality or forgery of a magnetic card.

To get the above stated objects, the magnetic card of the present invention is characterized by being braided therein with amorphous metal fibers parallelly arrayed, thereby, when the magnetic card is inserted to be between a driving coil and a detecting coil of the discriminating device, the driving coil forms an alternating magnetic field, and the detecting coil can detect the magnetic signals passing through the amorphous metal fibers, these detected signals are used to discriminate reality and forgery of the magnetic card.

The present invention will be apparent in its content of technique, features and effects after reading the detailed description of the preferred embodiment thereof in reference to the accompanying drawings.

### BRIEF DESCRIPTION OF THE DRAWINGS

FIG. 1 is an exploded perspective view showing the structure of the present invention;

FIG. 2 is a schematic view showing a magnetic card discriminating device of the present invention;

FIG. 3 is a schematic view showing a differential amplitude augmenter of the present invention;

FIG. 4 is a schematic view showing magnetic characteristics between driving signals and detested signals of the present invention;

FIG. 5 is a flow diagram showing operation of the magnetic card inserted into the discriminating device of the present invention.

### DETAILED DESCRIPTION OF THE PREFERRED EMBODIMENT

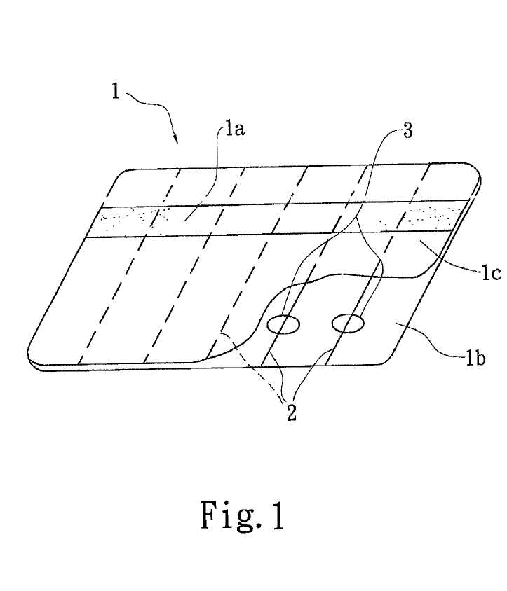

Referring to FIG. 1, a magnetic card 1 of the present invention is comprised of a front and a rear side. The front side is a thin resin sheet 1b recorded with the unit of issuing, the type of the card and points for attention; while the rear side is a thin resin sheet 1c and is provided with a magnetic track 1a recorded with magnetic data with ciphers for recording the balance of money. A plurality of amorphous metal fibers 2 are parallelly embedded between the front and rear sides.

The amorphous metal fibers 2 are easily pressed into the area between the front thin resin sheet 1b and the rear thin resin sheet 1c to be a interface between the front and rear sides. The amorphous metal fibers 2 cannot be seen from the appearance of the magnetic card 1. Sequence of arrangement and positions of embedment of the amorphous metal fibers 2 are related with punched holes 3 mechanically indicating the balance of money. The punched holes 3 means the corresponding parts of the amorphous metal fibers 2 being cut off, this may render detected signals on a signal receiving coil described later changed.

The amorphous metal fibers 2 of the present invention is made of soft magnetic material such as Fe—Si—B group or CO—Fe—Si—B group which is processed into the form of fibers. The soft magnetic material is available in general markets of magnetic material.

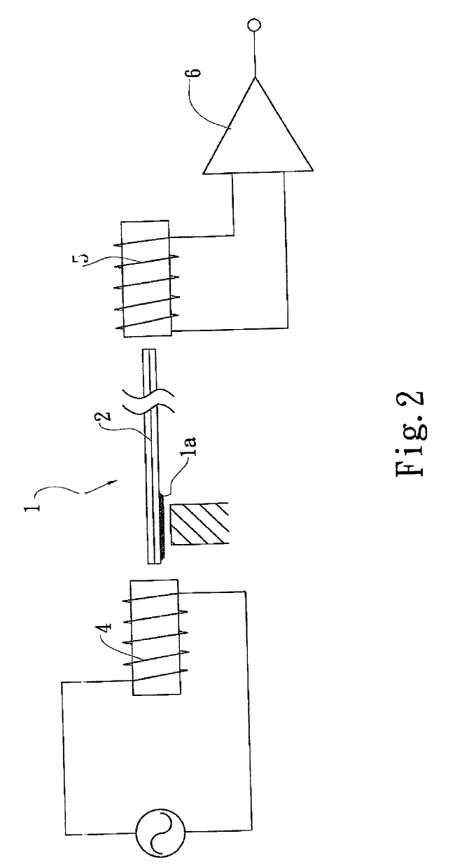

Referring to FIG. 2, the discriminating device of the present invention has an insertion slot with a width corresponding to the length of each of the amorphous metal fibers 2 embedded in the magnetic card 1. The insertion slot allows the magnetic card 1 to be inserted in a direction orthogonal to the surface of the paper of FIG. 2 with the magnetic track 1a of the magnetic card 1 facing down. The discriminating device is provided oppositely in the direction of the amorphous metal fibers 2 with a driving coil 4 and a detecting coil 5. Alternating driving signals will act on the driving coil 4; the detected signals passing through the amorphous metal fibers 2 will be put into the detecting coil 5. And the alternating driving signals of the driving coil 4 and the detected signals in the detecting coil 5 both pass through a differential amplitude augmenter 6.

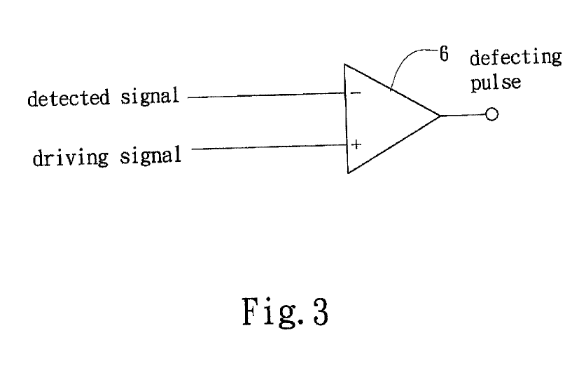

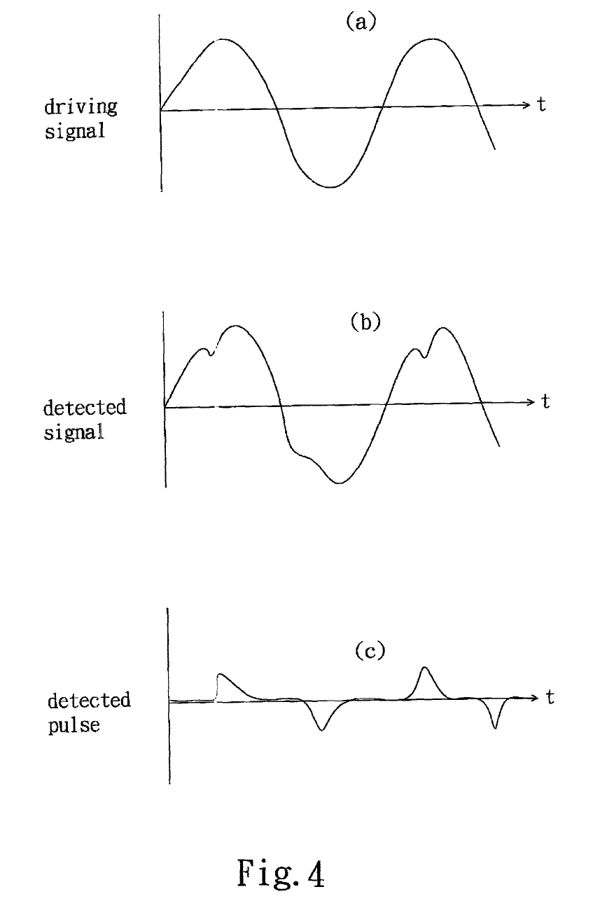

FIG. 4 shows the relationship among the alternating driving signals (a), detected signals (b) and detected pulses (c) of the differential amplitude augmenter 6. It can be seen from this drawing that, after the alternating magnetic field on the driving coil 4 acts on the amorphous metal fibers 2, and the magnetic flux passing through the amorphous metal fibers 2 is changed from “N” to “S”, i.e., when the voltage waveforms of the driving coil 4 are raised from “−” to “+” to make the magnetic field strength of the magnetized amorphous metal fibers 2 go up to a certain level, the magnetizing state will be suddenly changed to make overlapping of the pulse signals over the driving basic waveform. Certainly, when the magnetic flux of the amorphous metal fibers 2 is changed from “N” to “S”, the pulse signals and the driving basic waveform similarly overlap; thereby, when a differential amplitude augmenter 7 adequately augments the weak detected signals of the detecting coil 5, the signals of the augmenter 7 and the alternating driving signals of the driving coil 4 are input to the differential amplitude augmenter 61 shown in FIG. 3, the identical portions of the two kinds of signals will mutually offset, and the detected pulses (c) are obtained. The detected pulses (c) are not influenced by cutting off of the amorphous metal fibers 2 by the punched holes 3, therefore, they can be used to read the balance of money by the discriminating device.

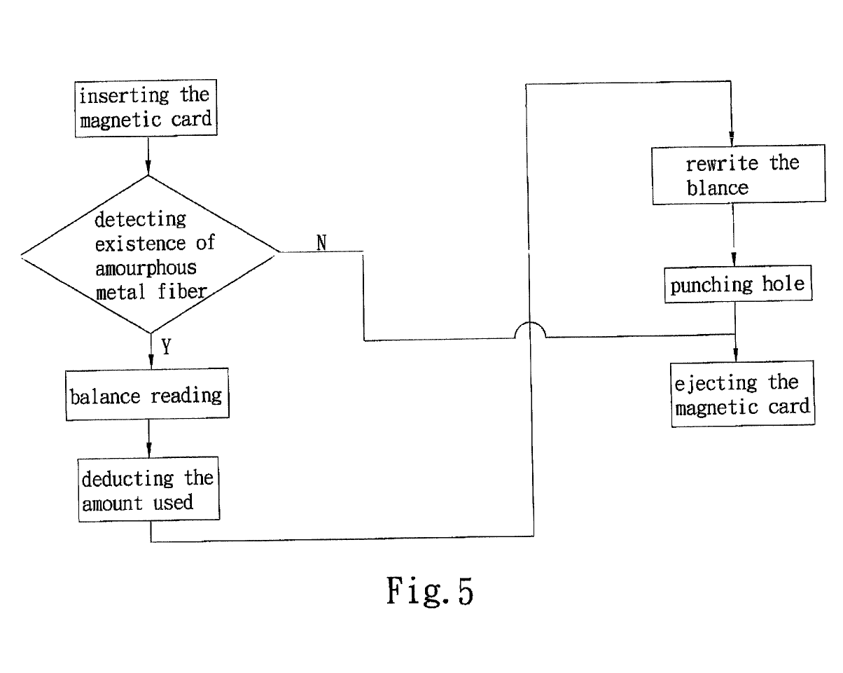

Referring to FIG. 5, operation of the magnetic card 1 from insertion to ejecting is described row. When the magnetic card 1 is inserted into the discriminating device, the latter detects firstly existence of the amorphous metal fibers 2. When the detecting coil 5 detects signals, it can read out the balance of money and record it in the magnetic track 1a; and if the detecting coil 5 detects no signal, it will be decided that the balance is zero or the magnetic card 1 is forged, and the magnetic card 1 will be ejected without the following operation of processing.

Moreover, when the magnetic card 1 is detected to have amorphous metal fibers 2, the amount of money expressed by the mechanical punched holes 3 is compared with the read amount of money recorded in the magnetic track 1a, if it is no error of the contents, the balance will be displayed; and when the amount of money to be used is acknowledged, it will be deducted from the balance, and a new balance will be rewritten in the magnetic card 1. The amorphous metal fibers 2 will be cut at the position corresponding to the amount of the balance to form trace of punched holes 3. When in completion of the above stated procedure, the magnetic card 1 is ejected. The discriminating device not only can check the balance, but also can detect existence of the amorphous metal fibers 2; therefore, it can elevate safety of the magnetic card 1.

From the description above, it can be very clear that the magnetic card and the discriminating device of the present invention not only can discriminate whether a magnetic card is embedded with amorphous metal fibers, but also can make comparison of the amount of money expressed by the mechanics punched holes with the read amount of money recorded in the magnetic track. By such comparison, safety of the magnetic card can be assured. According to the above statement, the magnetic card is very difficult to let know apparently whether amorphous metal fibers are embedded therein; arrangement of the amorphous metal fibers is unique in ratio, it is very difficult to make forgery.

In conclusion, the magnetic card with amorphous metal fibers and the discriminating device of the present invention not only gets rid of the defect of forgery of conventional magnetic cards; but also can definitely discriminate reality and forgery of the magnetic card by the discriminating device. The present invention is evidently advanced in comparison with conventional structures, and is industrial valuable.

Having thus described my invention, what I claim as new and desire to be secured by Letters Patent of the United States are:

1. A magnetic card discriminating device comprising:
an insertion slot with a width corresponding to the length of each of a plurality of amorphous metal fibers parallelly embedded in said magnetic card, said insertion slot allows insertion of said magnetic card therein;
a driving coil and a detecting coil provided oppositely at both sides of said slot;
when said magnetic card is inserted in said slot, said driving coil forms an alternating magnetic field, and said detecting coil detects the magnetic signals passing through said amorphous metal fibers, said detected signals of said detecting coil are used to discriminate reality and forgery of said magnetic card.

2. A magnetic card to take the place of a prepaying card for prepaying money under a predetermined amount, said magnetic card is characterized by: a plurality of amorphous metal fibers are parallelly embedded between a front and a rear resin sheet of said magnetic card.

3. A magnetic card as in claim 2, wherein, said amorphous metal fibers are allocated at the positions where holes indicating balance of money to be punched.
